(19) United States
(12) Patent Application Publication
(10) Pub. No.: US 2005/0075919 A1
(43) Pub. Date: Apr. 7, 2005

(54) Method for respondent-based real-time survey

(76) Inventor: Jeong-Uk Kim, Seoul (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/362,556

(22) PCT Filed: Aug. 9, 2001
(86) PCT No.: PCT/KR01/01354

(30) Foreign Application Priority Data
Aug. 23, 2000 (KR) 2000/49015

(51) Int. Cl. G06F 17/60

(52) U.S. Cl. 705/10

(57) ABSTRACT

The present invention relates to a method of conducting a respondent-driven survey in real time. An object of the present invention is to provide a real time and bi-directional respondent-driven survey method comprising the steps of forming a community composed of many respondents having common characteristics through an Internet network at the same period of time, requesting a purchase (survey request) in a predetermined time range by plural clients who need information on the community, selecting a client who provides the best condition among the plural clients, receiving payment from the selected client in real time, conducting the survey required by the client on the community in real time, and analyzing the collected results of the survey to be sent to the client.

### TECHNICAL FIELD

The present invention relates to a survey method, and more particularly, to a bi-directional respondent-based or respondent-driven survey method in which a survey is

### BACKGROUND ART

A survey is conducted in order to accomplish various purposes including a marketing research, consumer's behavior, user's satisfaction, advertisement effectiveness, consumer's preference, the sensitivity of market cost, brand awareness, a concept test, the estimation of market size, employee's satisfaction, the understanding of problems, and the like. The most typical survey method, i.e. an interview, is led by an interviewer, in which a respondent answers various questions provided by the interviewer. A skip pattern led by the interviewer has a disadvantage in that the interviewer's proceeding manners can affect the respondent's answer. Various list of questions and answers and supplementary information are stated on a question sheet used for a survey. The supplementary information is used for definitely representing the questions or for representing the forms of answers to the questions. Furthermore, the skip pattern by which some of the questions are skipped in accordance with the result of the answers is described in the question sheet in order to make the answers to the questions valuable. For example, in case of wishing to know whether respondents have ever utilized a specific product, respondents who have never utilized the product are caused to skip the relevant questions.

In case of a method having no intervention of the interviewer, the question sheet is provided to the respondent and the respondent himself conducts a survey while following a skip pattern therein. In this case, there is a disadvantage in that since the respondent may make a mistake, a complicated form of skip pattern is not applicable.

In order to overcome such disadvantages, an apparatus having processing capability such as a computer has been used for conducting surveys. Recently, as it becomes easier to access the Internet through a modem or other communication interfaces at an office or at home, such a survey conducted by using the computer is preferred more and more. The methods of conducting the survey by using the computer include the following.

A first survey method is to conduct the survey by installing an apparatus (such as a computer for the survey at a specific area such as a booth or a kiosk-installed place that is easily accessible to persons. The answers collected in each apparatus for the survey are gathered online or offline, and then the gathered answers are analyzed. A skip pattern in the survey is triggered by the apparatus for the survey so that there is no possibility of making a mistake. Nevertheless, there is a disadvantage in that the respondent must personally visit the place at which the apparatus for the survey is installed in order to answer the questions.

A second survey method is to conduct the survey by providing the respondent with independent software. In this case, the respondent can submit the answers to the questions online or offline. The apparatus for the survey used by the respondent (typically, a personal computer) triggers the skip pattern in the survey by using the provided software so that there is no possibility of making a mistake. Nevertheless, there is a disadvantage in that whenever the survey is conducted, software required for the survey must be programmed and distributed to the respondent.

A third survey method is to conduct the survey by using an electronic mail. In this case, the survey can be easily conducted to many persons. Nevertheless, there is a disadvantage in that, in case of conducting a survey in which the questions are complicated and interconnected with one another, it is likely that the respondent makes a mistake. In this method of using the electronic mail, an electronic mail server manages only distribution of the question sheets or delivery of the answers, and the skip pattern in the survey is triggered by the respondent.

A fourth survey method is to conduct the survey by using a web browser on a PC communication or Internet service. According to the survey using the web browser, there is an advantage in that the answers are easily collected online and it is possible to see the results thereof immediately. Nevertheless, there is a disadvantage in that the respondent may respond repeatedly the same question by clicking the BACK button of the web browser and accessing the web page including the questions that have been already responded, since the Internet basically performs intercommunication by a connectionless communication method.

Considering the aforementioned disadvantages, availabilities of the survey using the Internet can be further upgraded only when meeting the requirements that the restriction of the place must be overcome, the preparation and distribution of questions for the survey must be easily made, the complicated and interconnected skip pattern must be able to effectively managed, and the repetitive responses must be able to be prevented.

Furthermore, the conventional skip pattern has been triggered for each question sheet on the basis of each respondent's answer. This method may additionally require various unnecessary questions, and therefore, the research period of time may be prolonged and the inaccurate results maybe derived. In case of the research of public opinion, an individual opinion varies daily in accordance with important social issues, and therefore, a research of the public opinion that requires two or three days may result in inaccurate and useless information. An example of the inefficient survey occurring when the skip pattern is triggered on the basis of the individual answer is as follows. When candidates c and d of an A party, and candidates e and f of a B party intend to run for election, assume that a survey for predicting only the final results is conducted. In this case, the survey for estimating who is a strong candidate between two candidates of the parties and the survey for predicting election results among respective candidates of the A and B parties must be conducted simultaneously. Therefore, questions for predicting the election results between c and d, e and f, c and e, c and f, d and e, and d and f are required. Assuming that the candidates c and e are strong candidates of each party, the questions between c and f, d and e, and d and f become unnecessary. If a skip pattern can be performed for an entire group of the respondents, the questions for estimating respective strong candidates of each party, i.e. questions between c and d, and e and f, is firstly asked, the results of responses is then analyzed, and the questions between c and e can be asked. Therefore, it is possible to conduct the survey more efficiently.

In case of the methods using the interview, the e-mail or the like, in which the response results are collected in a lump and then processed, the skip pattern cannot be performed for the group of the respondents. On the contrary, in case of a focus group in which panels are gathered at a specific place in real world (offline) and the interview is performed, the skip pattern for the group can be triggered while the survey is being conducted. Nevertheless, there is a disadvantage in that the cost of the survey is excessive. The conventional online survey cannot trigger the skip pattern for the group of the respondents, since the times at which the respondents participate in the survey are different from one another and the time synchronization among the respondents does not exist. In addition, there is a disadvantage in that one person can repeatedly answer the same question, since the times participating in the survey are different from one another. However, if the respondents can answer the questions simultaneously in a predetermined period of time online, it is possible to apply the skip pattern the group of the respondents.

Various online selling methods other than conventional selling methods have been efficiently used. Among them, the auction is a seller-driven sales system in which a seller provides a product of which price has not been determined and the product is sold to a buyer who presents the highest price among buyers.

The reverse auction is a buyer-driven sales system in which a buyer provides the purchase price and condition for a product and buys the product from a seller who presents the best condition among sellers meeting the condition. Offline survey market is conventionally a client (buyer) driven system. The reason is that, if a client requests a survey company to conduct a survey, the survey company searches respondents (sellers) and buys answers (products) for questions. In this case, the selection of the respondents varies in accordance with the request contents. It is almost impossible to build up a respondent (seller) driven offline survey market. The reason is that the costs required for collecting many respondents and for searching a client are even greater than the product value (value of the information obtained from the respondents). However, since the Internet has not the regional restriction, the physical distribution cost is not required, and it is easy to group the persons having common characteristics into a community and to search a client requiring information on the community.

The survey requires complicated procedures, and a lot of time and working hands. Assume that in order to develop an electronic product for teenager girls, an A company intend to determine the concept of the developing product. A person in charge must obtain an internal approval for financial payment, prepare questions required for a request of a survey, and contract with a survey company to conduct the survey. In order to plan the survey, the person in charge must predict the results of responses and prepare the questions on the basis thereof. In some cases, it often happens that the results of the survey become useless due to unpredicted results of responses. The survey company selects target persons of the survey and conducts the survey by using a telephone or e-mail. The survey company collects and classifies the responses, and then, makes a report on the researched contents and delivers the report through an official channel. After a client company investigates the report, if the contract is fulfilled satisfactorily, the client company pays the cost of the survey. One of illogicalities existing in the requests of the survey is that the price for the survey is determined based on the number of the respondents. As for a client who intends to conduct a survey including one or two simple questions, such price determination is not proper to the client. Furthermore, since a path of reporting the results of the survey to a manager of the client company is complex, the results may be distorted by someone on the way of the path of reporting the results of the survey.

### DISCLOSURE OF INVENTION

The present invention is contemplated for solving the problems of the conventional survey methods. An object of the present invention is to provide a real time and bi-directional respondent-driven survey method comprising the steps of forming a community composed of many respondents having common characteristics through an Internet network at the same period of time, requesting a purchase (survey request) in a predetermined time range by plural clients who need information on the community, selecting a client who provides the best condition among the plural clients, receiving payment from the selected client in real time, conducting the survey required by the client on the community in real time, and analyzing the collected results of the survey to be sent to the client.

A central controller (server) in the present invention provides a real time and bi-directional respondent driven survey system wherein a community composed of many respondents having common characteristics is formed through an Internet network at the same period of time, survey requests of plural clients are received in a predetermined time range, a client who provides the best condition is selected among the plural clients, payment from the selected client is received in real time, the survey required by the client is conducted on the community in real time, and the collected results of the survey is analyzed to be sent to the client. The central controller, the clients requesting the surveys and the respondents are interconnected through the Internet or other communication networks.

Furthermore, the present invention provides a method, which allows the clients, and respondents who wish to participate in a survey to actually take part in a specific survey plan. A planner of the survey determines the participants and the subject of the survey, the date of conducting the survey and the predicted number of the participants and informs the central controller of the plan of the real time survey. The participants of the survey are classified according to attributes such as sex, age and the like, which each person cannot change easily and arbitrarily. The subject of the survey is a very arbitrary attribute like a personal taste for an object or concept and indicates an intended direction of the survey. The subject of the survey is made to search efficiently the plan of the survey by classifying each subject of the planned survey into simple and compound subjects. As for a difference between a conventional survey system and the present invention, the conventional survey system causes the survey company to search the respondents in accordance with the request contents, whereas the present invention establishes the plan of the respondents having common characteristics in advance and then searches a client and the respondents.

Furthermore, the present invention provides a method of managing the clients and the respondents of the survey by means of a membership system in order to improve reliability of the real time survey. When a person or a company wants to subscribe to a member of clients of the survey, he/she is connected to the central controller, obtains a client ID through a process of user registration, downloads a request program for the real time survey from the central controller and then installs the program into the client's controller. Furthermore, a client having been registered as a user must inform an administrator of the central controller of his or her credit card number by a telephone or a facsimile. When a person wants to participate in the survey as a respondent, he/she is connected to the central controller, obtain a respondent ID through the process of user registration, downloads a response program for the real time survey and then installs the program into a respondent's controller.

When a client does not pay the fee with his/her credit card or a respondent arbitrarily stops answering questions of the survey while conducting the survey, the central controller stepwise lowers an evaluation grade of the member corresponding to the client or the respondent. When a client or a respondent logs on the central controller, the central controller determines whether the client or the respondent can access thereto on the basis of the evaluation grade of the member stored in a database. In addition, the client or the respondent normally logged on the central controller can select a plan of a real time survey which he/she wants to participate in among plans of real time surveys provided from the central controller.

Another object of the present invention is to provide a method of continuously maintaining the predetermined number of respondents while conducting a specific real time survey. When a respondent wants to participate in a specific plan of a survey, the central controller determines whether the number of respondents connected thereto at present exceeds the predetermined number of participants in the plan. If it is determined that the number of the currently-connected respondents does not exceed the predetermined number of the participants, the central controller sets the respondent as a response participant, and if not, it sets the respondent as a response waiter. If a participant does not take part in the survey during a predetermined period of time, the central controller changes the response waiter as the response participant in the prioritized order, so that it can continuously maintain the predetermined number of the participants while conducting the real time survey.

A further object of the present invention is to provide a bi-directional respondent-driven survey method by which a client of a survey can determine whether the client requests a survey by providing the client with information on response participants in a specific real time survey and response waiters.

A still further object of the present invention is to provide a bi-directional respondent-driven survey method by which a client of a survey transmits request conditions including the number of questions and answers, request cost and whether results of the survey will be opened to the public, and the central controller determines a request presenting the best request condition in real time and allows the survey request fee of the determined client to be settled in real time.

A still further object of the present invention is to provide a method of preparing a survey form capable of applying a complex skip pattern to a group of respondents or a respondent and to provide a bi-directional respondent-driven survey method of conducting the survey on the respondents by using the prepared survey form and reporting results of the survey. When a client requests a survey, a client prepares a survey form in his/her controller and transmits it the central controller. The central controller transmits the questions included in the survey form to the response participants and collects answers to the questions from the controllers of the participants. The skip pattern is applied to the collected answers to the questions, and then the next question is determined.

Furthermore, according to the present invention, the central controller provides the response results of the survey obtained in real time to a client's controller in real time.

Furthermore, according to the present invention, the central controller gives the participants in the real time survey mileage points having attribute of money or compensation.

In order to accomplishing these objects, the present invention provides a real-time and bi-directional respondent-driven survey method comprising the survey plan providing step of connecting a computer of a survey planner with an Internet, recording the survey plan to be conducted in a predetermined period of time into a survey plan database, and providing the survey plan to a plurality of survey request expectants and survey response expectants recorded in a member database through the Internet; the qualification granting step of online receiving applications of a plurality of survey respondents who want to participate in the survey plan through the Internet, recording the survey respondents into a survey participant database, and granting the response participants qualifications for responding to a real-time survey to be conducted based on the survey plan; the client determining step of providing the plurality of the survey request expectants with information on the response participants including the number of the response participants, a sampling error, ages, sexes, resident regions and the like, receiving a survey request condition including question contents, the number of questions, request costs, whether the results of the survey will be opened to the pubic and the like from the plurality of the survey request expectants, and determining a request expectant who has presented the best request condition as a client; and the survey conducting step of recording the questions provided by the determined client into a question database, providing the questions to the plurality of the response participants in real time through the Internet, collecting the results of the responses to the questions from the response participants in real time through the Internet, recording the results into a response result database, and providing the results to the determined survey client in real time through the Internet.

### BRIEF DESCRIPTION OF DRAWINGS

FIG. 1 is a block diagram schematically showing an Internet network performing a bi-directional respondent-driven survey method according to the present invention.

FIGS. 2a to 2f are diagrams showing a database constructed in a central controller for a survey planner, which plans and conducts the bi-directional respondent-driven survey according to the present invention.

FIGS. 3a to 3c are flowcharts illustrating the bi-directional respondent-driven survey method according to the present invention.

FIGS. 4a to 4e are diagrams showing questions useable in the bi-directional respondent-driven survey method according to the present invention.

### BEST MODE FOR CARRYING OUT THE INVENTION

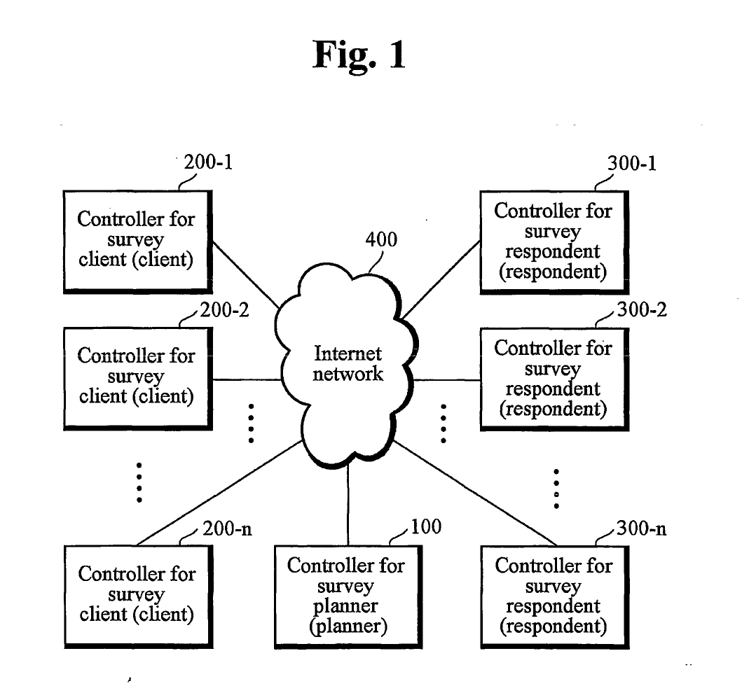

Hereinafter, a preferred embodiment of the present invention will be described in detail with reference to the accompanying drawings. As shown in FIG. 1, the present invention has the configuration that a central controller 100 for a survey planner, controllers 200-1˜200-n requesting a survey, and controllers 300-1˜300-n for respondents participating in the survey are interconnected with one another through an Internet network 400. It will be readily understood by a person having ordinary skill in the art that the Internet network 400 may be formed by means of general telephone networks, dedicated line networks, wireless networks, satellite networks, microwave networks and the like.

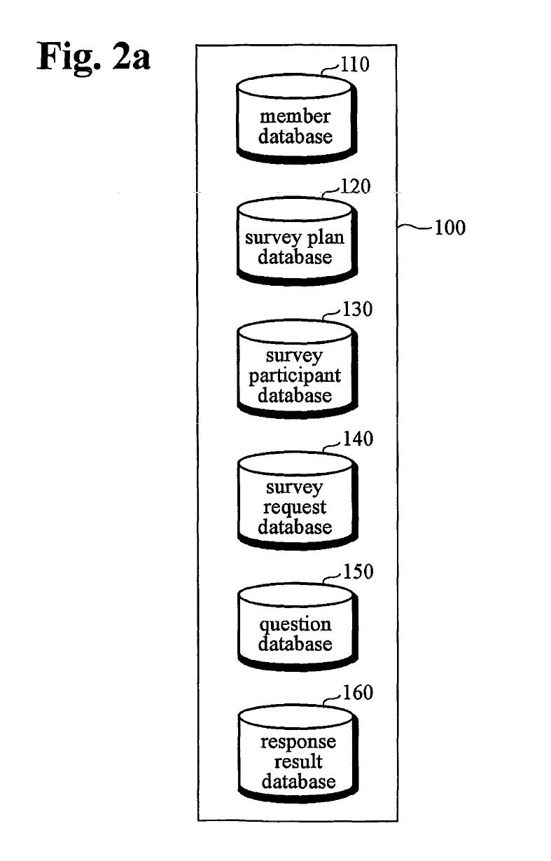

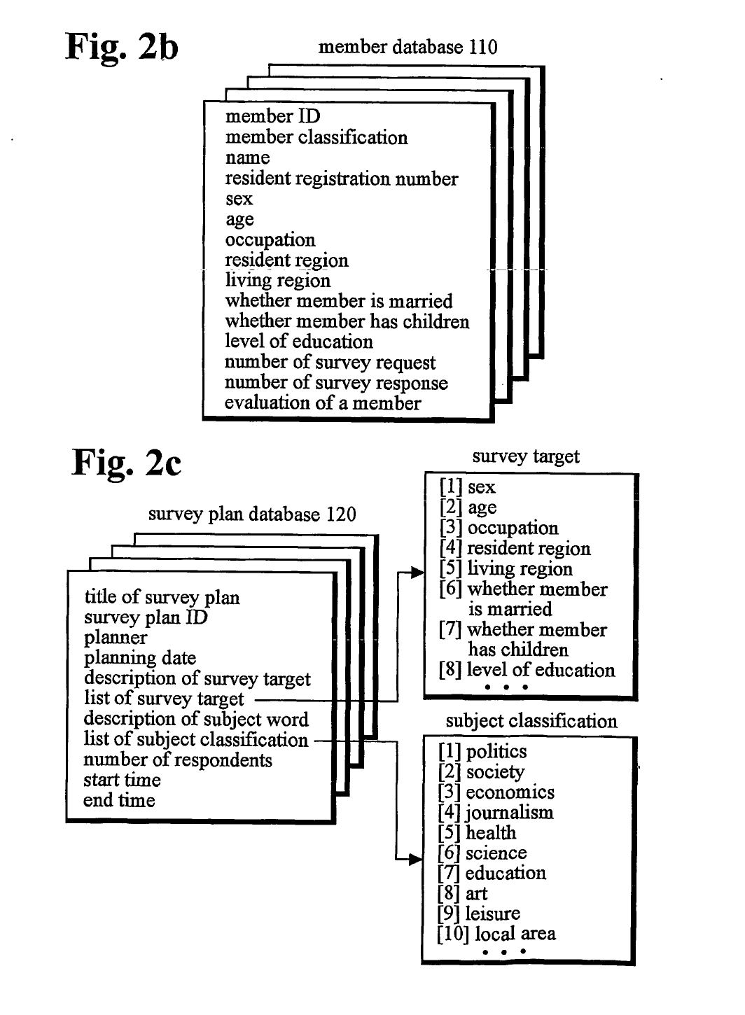

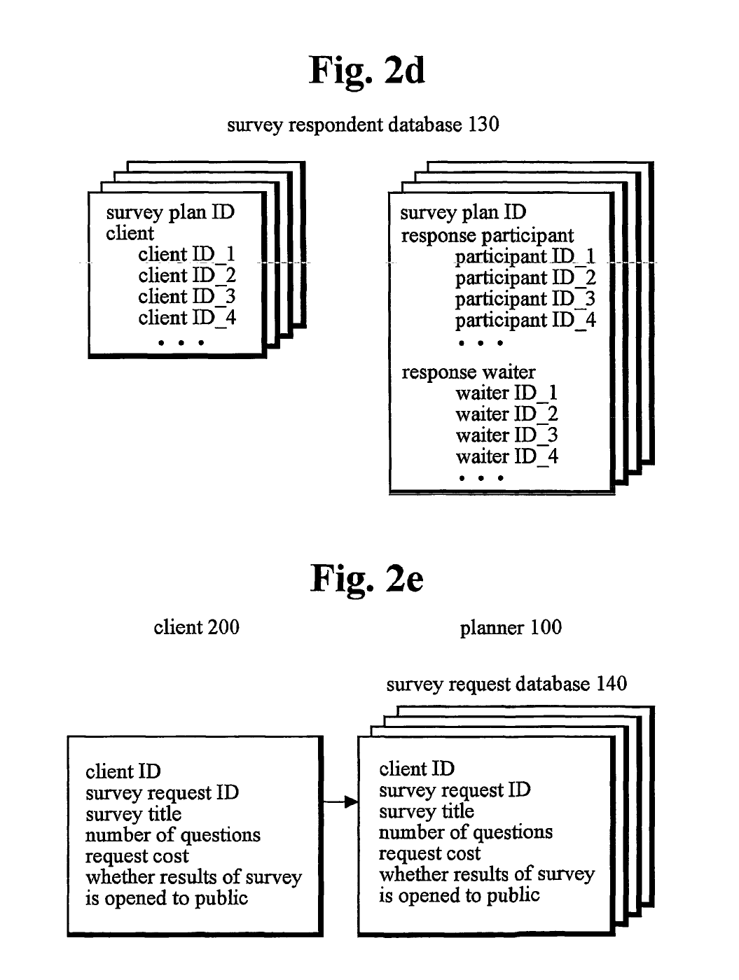

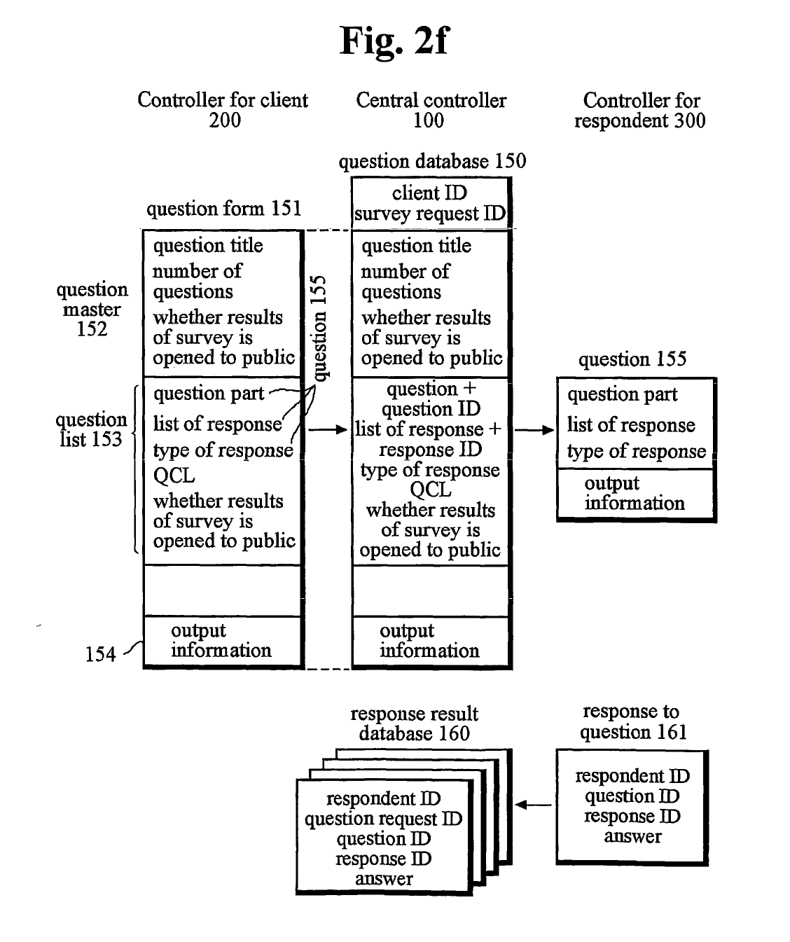

FIG. 2a shows the types and configurations of databases into which a central controller 100 for a planner of the survey stores information received from a controller 200 (hereinafter, the term “client” may be used for designating “controller for the client”) for a client of a survey and a controller 300 (hereinafter, the term “respondent” may be used for designating “controller for the respondents”) for a respondent of the survey.

As shown in this figure, the central controller 100 includes a member database 110, a survey plan database 120, a survey participant database 130, a survey request database 140, a question database 150 and a response result database 160.

The member database 110 stores information on clients and respondents registered as members and can be configured as shown in the FIG. 2b. The member database 110 stores information on the members. The information on the members includes characteristic information that cannot be changed during a short period of time, in order to increase the reliability of the real time survey. As shown in the figure, the information on the members includes a member ID, member classification, a name, a resident registration number, an age, an occupation, a resident region, a living region, whether a member is marred or not, whether a member has children, a level of education, the number of survey requests (in case of a client), the number of survey responses (in case of a respondent), the evaluation of a member and the like.

Here, the member classification indicates whether a member is registered as a survey client or as a survey respondent. The number of survey requests is stored as the number of the surveys requested by the survey client. The number of survey responses is stored as the number of the surveys responded by the survey respondent. The evaluation of member is used for restricting connection of an evil member and is stored as an evaluation grade of a member.

FIG. 2c shows the survey plan database 120. As will be described below, a survey planner establishes a survey plan in order to conduct the respondent-driven real time survey. In establishing the survey plan, the number of respondents who participate in the survey and their common characteristic must be determined and it should be determined what number of questions will be provided to the respondents. The real time survey plan must include its title, its ID, a planner, a planning date, the description of a survey target, a list of the survey target, the description of a subject word, a list of subject classification, the number of respondents, a start time and an end time. The survey plan ID is an identifier for uniquely identifying each survey. The description of the survey target is to describe the characteristic of the respondents of the survey in a general language. The list of the survey target uses the information on the survey target stored in the member database 110. The list of the survey target may include various items and designate a specific value or a predetermined range of values. For example, in planning a survey which is conducted on the respondents whose ages are from thirty to thirty four or from forty to forty four and whose children are one or three, the list of the survey target is {age=(30-34, 40-44), the number of children=(1,3)}. The description of a subject word is to describe the field on which the survey is focused in a general language. The list of the subject classification allows each survey plan to be easily searched by classifying the description of the subject words according to the fields of the subject. Each survey plan may be fallen in a plurality of the subject classifications.

FIG. 2d shows the survey participant database 130. The survey participant database 130 is constructed to be arranged according to a survey plan ID, a client, a response participant and a response waiter. In the present invention, the respondents are classified into the response participants and the response waiters and the survey is conducted on the response participants. However, if a response participant unfaithfully participates in the survey, a response waiter having the highest priority is converted into a response participant.

The response participant and the response waiter are determined in accordance with the order of requests of participation in the survey.

FIG. 2e shows the survey request database 140. When a client requests a survey, the central controller 100 stores the survey request into the survey request database 140. The survey request comprises of a client ID, a participating survey request ID, a survey title, the number of questions, request costs and whether survey results are opened. The survey request ID is used for discriminating each survey request, since selection of the survey request from real time survey plans is performed continuously.

FIG. 2f shows a survey form 151 that is used for describing the contents of the survey by a client of the survey, and the contents of the question database 150 in the central controller 100. The question form 151 is composed of a question master 152, a question list 153 and output information 154. The question master 152 is a portion of the information provided upon request of the survey and is comprised of a question title for explaining the contents of the survey which a client wants to request, the number of questions included in the survey request, and whether the survey results are opened. The question list 153 is to describe many questions 155 and additional information on the respective questions. The question 155 is composed of a question part, a list of responses, and a type of response. The additional information is QCL (Question Control Language; it will be described in detail later) for applying a skip pattern and whether the survey results are opened to the public. The information on whether the survey results are opened to the public included in the question list 153 has priority over the information on whether the survey results are opened to the public included in the question master 152. That is, even though the question master 152 indicates that the survey results should be opened, when the question list 153 indicates that the survey results should not be opened, the survey results are not opened. The output information 154 is outputted to all persons participating in the real time survey and is used for an advertisement. The central controller 100 assigns a question ID and a response ID to the question part and the list of responses included in the question form, respectively, and then transmits them to the controller 300 for a respondent along with the output information. After the respondent answers to the questions, the controller 300 for the respondent transmits a response 161 to the question to the central controller 110. The response 161 to the question is composed of a respondent ID, a question ID, a response ID and an answer. The central controller 100 adds the question request ID to the response and thus constructs a response result database 160. The central controller 100 performs the QCL sentence for the collected response results and determines the next question. After conduction of the requested survey, it transmits the analyzed results to the client 200.

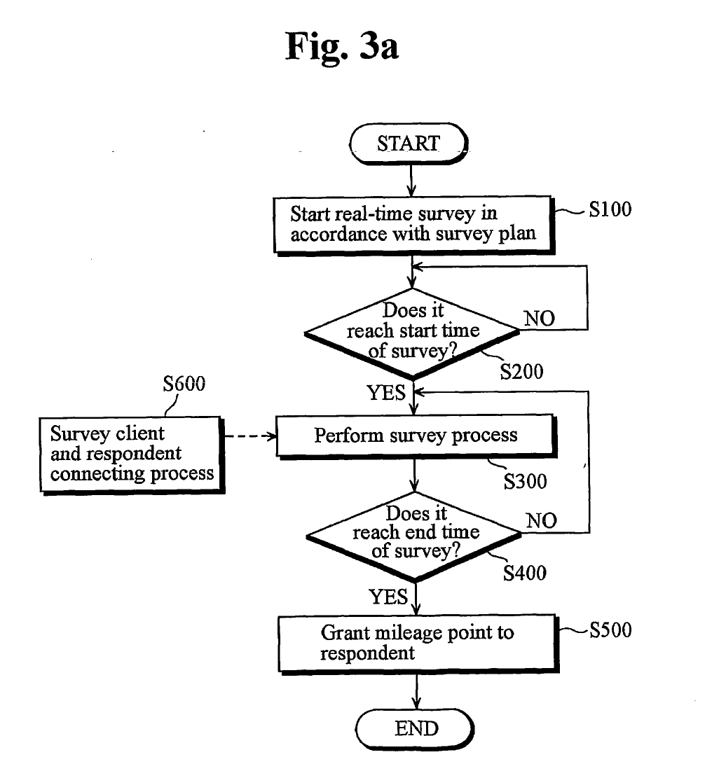

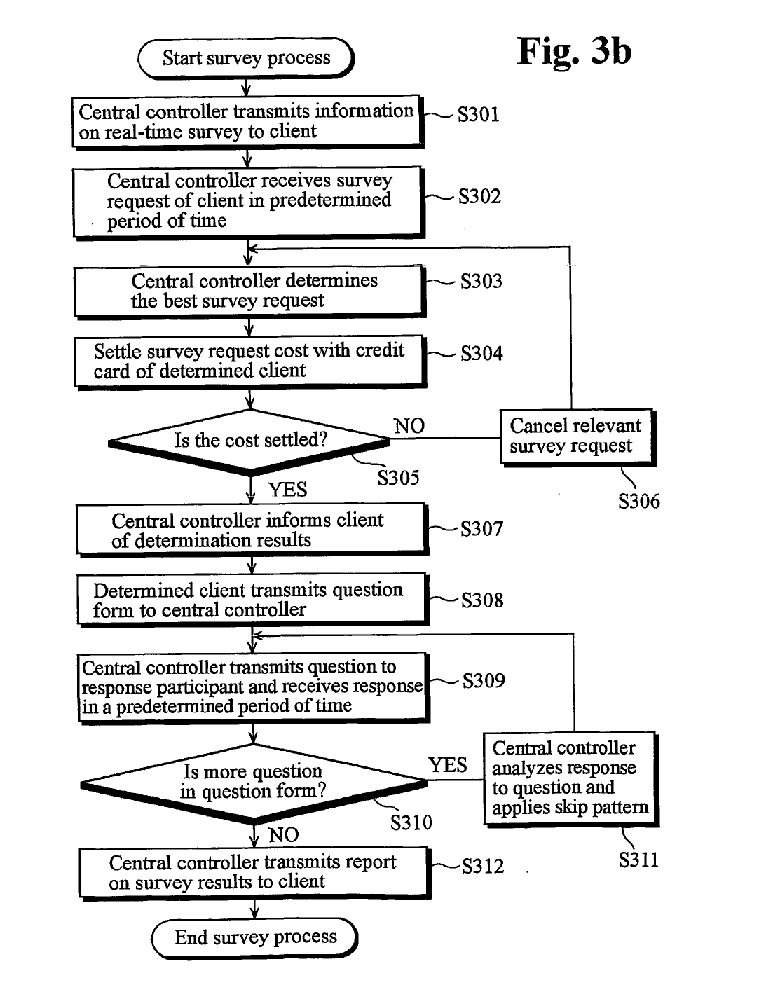

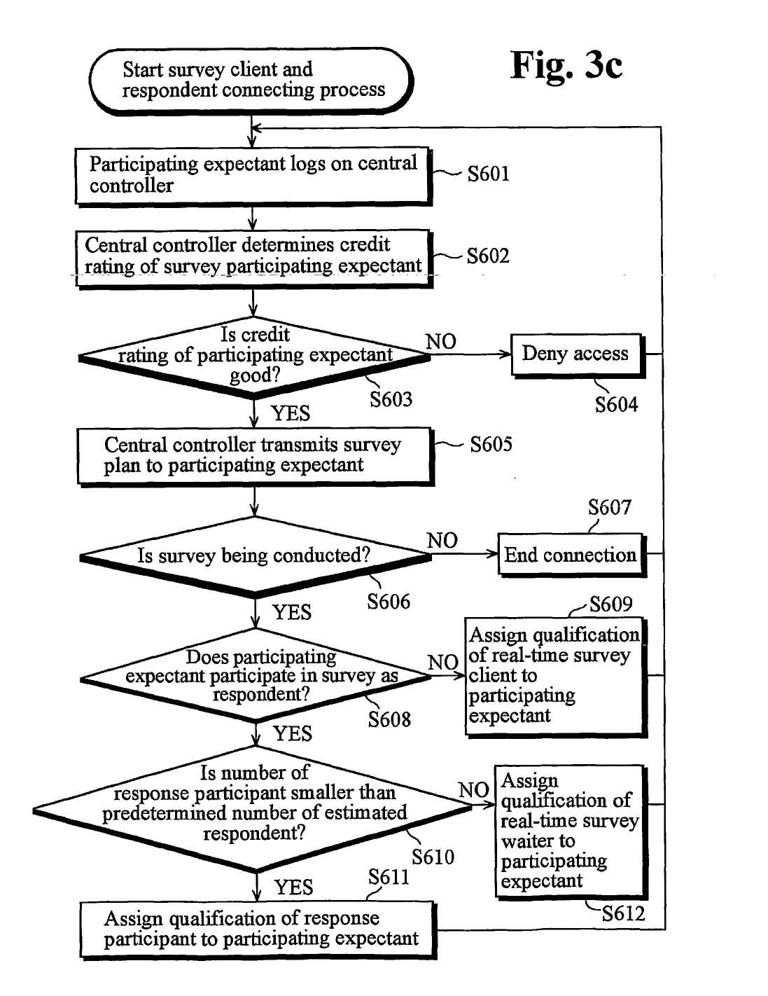

FIG. 3a shows the entire process of the real time survey conducted by the central controller 100 having the aforementioned configuration. As shown in the figure, the central controller 100 starts the real time survey in accordance with the real time survey plan at step S100. If it reaches the start time of the survey planned in the survey plan (step S200), the central controller 100 performs the survey process (step S300) in which a request for the survey is received and the survey is conducted in real time. This survey process is repeatedly performed until the end time of the survey (step S400). After ending the real time survey process, the central controller 100 grants a service mileage to respondents who participate in the survey and terminates the real time survey. The clients and respondents who will participate in the survey are determined in accordance with the survey client and respondent connecting process (step S600).

FIG. 3b shows a survey process conducted in real time. This process is a procedure by which a real time survey is conducted, and a survey request may include one or more questions. When the real time survey starts at step S301, the central controller 100 transmits respondent-related information such as the number of respondents participating in the survey, sampling error, and the number of questions capable of being performed in the survey to a survey request expectant 200 stored in the survey participant database 130. The survey request expectant receives these information and then transmits a survey request condition including a survey title, the number of questions, a request cost and whether the survey results are opened to the public to the central controller 100 in a predetermined period of time, if necessary (step S302). Generally, before the survey request expectant participates in the real time survey, he/she prepares questions to be provided in the survey.

At step S303, the survey request conditions from the request expectants are stored in the survey request database 140 of the central controller 100 as shown in FIG. 2E (step S303), and the central controller 100 determines a request expectant 200 presenting the best condition among the survey request conditions as a survey client (step S304). The client ID, the number of questions, the request cost and whether the survey results are opened to the public are used for determination of the survey client. Upon determination of the survey request, the most difficult problem is that the respective numbers of questions for respective survey requests differ from each other. Therefore, a converted request cost for each survey request is calculated and then, a survey request that presents the highest converted request cost is selected. The simplest method of calculating the converted request cost is to divide the request cost by the number of questions. Alternately, another method is to assign a weighting factor according to the number of questions and to divide the requests cost by the weighting factor. For example, when the number of questions is 2, 3 and 4, respectively, the weighting factor is 2.5, 4 and 5.5, respectively. When a customer has requested the large number of surveys or when the survey results can be opened to the public, the request cost may be discounted.

At step S304, the central controller 100 settles the survey request cost with the credit card of the survey client through telephone communication or online connection with a credit card company. As the result of processing step S304, if the request cost cannot be settled due to the shortage of his/her balance or other reasons (step S305), the central controller 100 cancels the survey request (step S306), returns the procedure to step S303, and then re-determines a client presenting the best condition except for the canceled client. After the determination of the client, the central controller 100 informs the client of the determination as the survey client (step S307). The client determined at step S308 transmits his/her already prepared question form to the central controller 100. The central controller 100 stores the received question form into the question database 150, transmits the question in the received question form to each respondent (response participant), and stores responses of the respondents provided in a predetermined period of time into the response result database 160 (step S309). In these processes, although the survey is firstly conducted on the response participants, when the number of the response participants is smaller than the target number of respondents, the aforementioned processes should be performed by inviting response expectants having higher priorities to the survey as the response participants as described above.

After performing step S309, if there is more questions in the question form (step S310), the central controller analyzes the responses to the questions and applies a skip pattern to the respondents, and then proceeds to the process of transmitting the next question to the respondents at step S311. However, as the result of performing step S310, when all the questions of the client is completely processed, the central controller 100 prepares a report on the survey results and transmits it the client (step S312). As the result, one survey request is completed.

On the other hand, in the aforementioned present invention, the real time processing allows a time interval between the survey request and the survey conducted on the respondents to be several periods thereof in order to have some time to spare. For example, when a time interval of 2 periods is allowed, after determining first and second request surveys, the first request survey is conducted while determining a third request survey. When the first request survey is completed, the second request survey is conducted while determining the forth request survey.

FIG. 3c shows the procedure in which a request expectant and a response expectant (hereinafter, referred to as “participating expectant”) that want to participate in the survey log on the central controller 100. This log-on process is infinitely repeated and the client and the respondent determined by this process can participate in the survey process. A participating expectant logs on the central controller 100 through the Internet network 400 (step S601). At step S602, the central controller 100 determines the identity of the participating expectant by using the member ID stored in the member database 110 and searches the evaluation grade of the member (step S602). Then, it is determined at step S603 whether the credit rating of the participating expectant is good. If it is determined at step S603 that the credit rating of the participating expectant is good, the central controller 100 transmits the survey plan stored in the survey plan database 120 to the participating expectant (step S605) and if not, prohibits the access of the participating expectants (step S604).

The survey plan includes the survey conducting time, the common characteristic of respondents participating in the survey, the predicted number of respondents participating in the survey and the like. After performing step S605, if it is determined at step S606 that the survey is not being conducted, the central controller 100 ends the connection of the participating expectant (step S607). If it is determined at step S608 that the participating expectant wants to participate in the survey as a survey client, the central controller 100 assigns the participating expectant a real time survey client (step S609). In addition, if it is determined at step S608 that the participating expectant wants to participate in the survey as a respondent, it is determined at step S610 whether the number of the response participants is smaller than the predetermined number of the estimated respondents. If so, the central controller 100 allows the participating expectant to be a response participant capable of participating in the survey (step S611). Furthermore, if the number of the response participants is greater than the predetermined number of the estimated respondents, the central controller 100 allows the participating expectants exceeding the predetermined number to be response waiters (step S612). After storing the client, the response participants and the response waiters into the survey participant database 130, the central controller 100 waits for log-on of other participating expectants.

When conducting the real time survey, since it cannot be assured that all responses from the respondents are transferred to the central controller in a predetermined period of time, the present invention sets response expectants corresponding to 110 to 130% of required survey respondents as the number of response participants in the order of access.

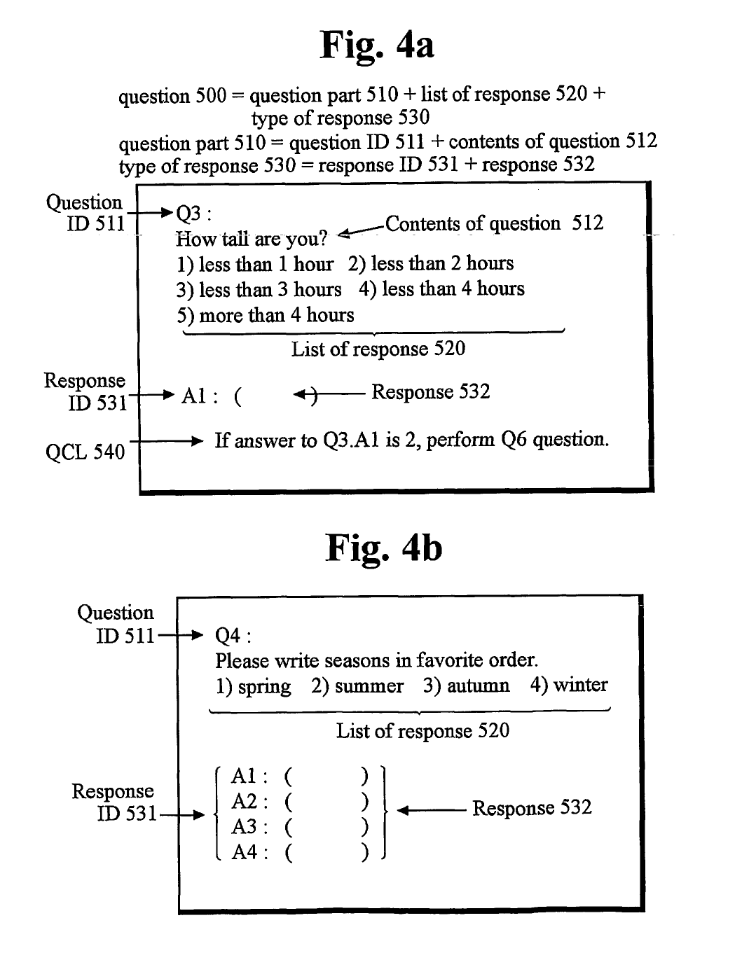

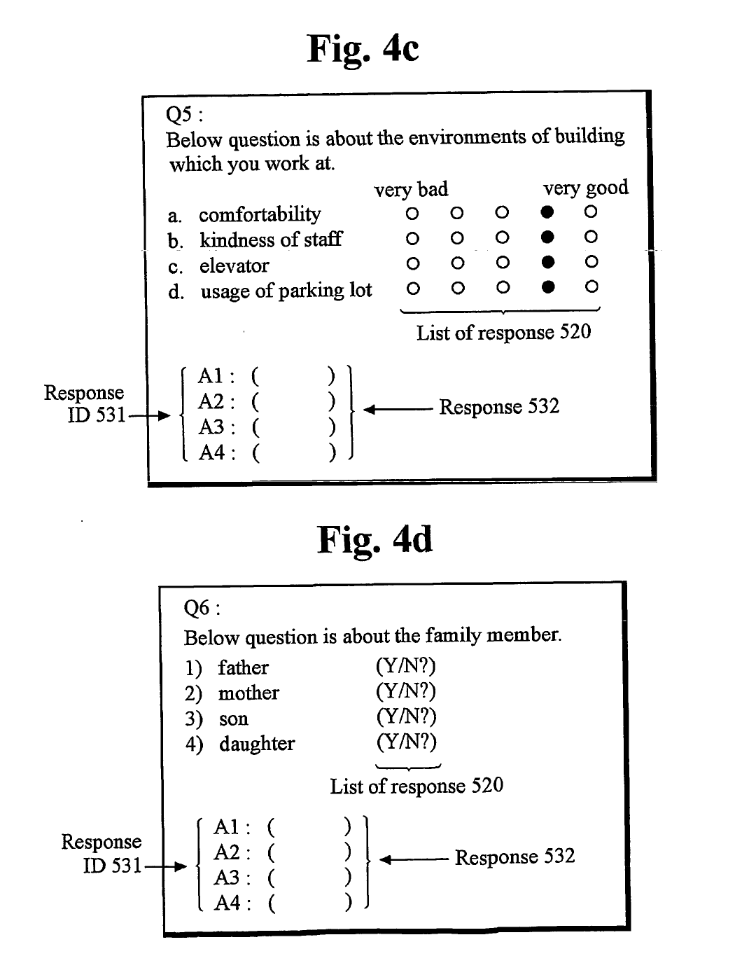

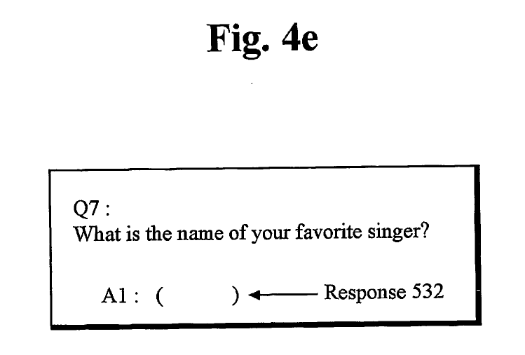

FIGS. 4a-4e show various possible questions capable of being managed in the survey, and FIGS. 4a-4d show closed type of questions and FIG. 4e shows an open type of a question. In actual implementation, it is necessary to determine an adjusted request cost in accordance with the types of questions and responses considering the difficulty between a question requiring a complex type of response and a question requiring a simple selective type of response.

FIG. 4a shows a selective type of question frequently used in the survey in which an answer is selected among a predetermined list of responses. The question 500 consists of a question part 510, a list of responses 520 and a type of response 530. The question part 510 consists of a question ID 511 and contents of the question 512. The question ID is an identifier for uniquely identifying the question part in survey request. The type of response 530 consists of a response ID 531 and a response 532. One question may have various responses. The response ID 531 is an identifier for uniquely identifying a response in a question. In FIG. 4a, there is only one response ID 531. FIG. 4b shows a type of question having a plurality of responses and the responses are mutually related to one another. A question Q4 has four response IDs 531 and four responses 532. FIG. 4c shows a type of a question having a plurality of responses that are not mutually related to one another and is the type of the question greatly considers the conveniences of the question. In this case, a question Q5 has also four response IDs 531 and four responses 532. The response is a value selected from the predetermined response list 520. FIG. 4d is a type of a question having a plurality of responses that are not mutually related to one another in the same way as FIG. 4c. Contrary to FIG. 4C, the response to the question of FIG. 4d is selected as one of YES and NO.

FIG. 4e is an open type of question in which a respondent can select a response freely. The open type of question may be made to have various responses or to select a response only in a limited range.

In the present invention, a Question Control Language (hereinafter, referred to as “QCL”) shown in Table 1 is defined in order to implement a skip pattern. The QCL is applied to both the open type of question and the closed type of question. The sentence structure of the QCL is represented according to a Backus Normal Form grammar and has a construction similar to a SQL (Structured Query Language).

The QCL includes (1) a form containing a question or questions capable of being performed only when a respondent selects specific responses to one or more questions and (2) a form containing a question or questions capable of being performed only when a group of the respondents select specific responses to one or more questions. In case of applying an individual skip pattern such as the form (1), a keyword “EACH” is used, and in case of applying a skip pattern for a group such as the form (2), a keyword “GROUP” is used. As shown in Table 1, the QCL basic sentence can be largely classified into 3 types. The first sentence is “if_statement” and takes a form of “IF (condition) THEN (statement) ELSE (statement)”. After analyzing the results of responses to the question, a next question is determined or a current survey request is ended. The second sentence is “goto_statement” and takes a form of jumping to another question irrespective of the results of the responses. The third sentence is “return_statement” and represents the ending of the current survey.

The results of the responses may be classified into a case of using a list number responded by a respondent and a case of using an actual value meant by the list number responded by a respondent. A “CONTENT ( )” corresponds to the case of using the actual value. As the “answer-ref”, various arithmetic operations can be performed and the meaning of each function is shown in Table. 1.

TABLE 1

| | Applicable | |
|---|---|---|
| Function | object | Meaning |
| COUNT (*) | Group | The number of the |
| | | respondents who are |
| | | expected to participate |
| | | in the real time survey |
| AVG (answer-ref) | Group | Average value for the |
| | | answer-ref |
| MAX (answer-ref) | Group | Maximum value for the |
| | | answer-ref |
| MIN (answer-ref) | Group | Minimum value for the |
| | | answer-ref |
| SUM (answer-ref) | Group | Sum value for the |
| | | answer-ref |
| COUNT (answer-ref) | Group | The number of respondents |
| | | participating in the |
| | | answer-ref |
| NTH_VAL (answer-ref, | Group | A response ranking No. |
| rank) | | “rank” in numbers |
| | | among the answer-ref |
| NTH_NUM (answer-ref, | Group | The number of respondents |
| rank) | | selecting the response |
| | | ranking No. “rank” |
| | | in numbers among the |
| | | answer-ref |
| NTH_PCT (answer-ref, | Group | The rate of respondents |
| rank) | | selecting the response |
| | | ranking No. “rank” |
| | | in numbers among the |
| | | answer-ref based on the |
| | | number of respondents |
| | | participating in the |
| | | answer-ref |
| VALUE (answer-ref) | Individual | Response to answer-ref |

QCL Grammar Rules
statement

::= {GROUP|EACH} ′:′ control_statement

control_statement

::= if_statemnet ′;′

|goto_statement′;′
|return_statement′;′

if_statement

::= IF′(′condition′)′ THEN control_statement
[ELSE control_statement]

goto_statement

::= {GOTO|GO TO} question

return_statement

::= RETURN[{TRUE|FALSE}]

condition

::= condition{OR|AND} condition

|NOT condition
|′(′condition′)′
|predicate

predicate

::= comparison_predicate

|between_predicate
|like_predicate
|test_for_null
|in_predicate
|all_or_any_predicate
|scalar_exp

scalar_exp_commalist

::= scalar_exp

|scalar_exp_commalist’,’scalar_exp

scalar_exp

::= term

|scalar_exp{+|−}term

term

::= factor

|term{*|/} factor

factor

::= [+|−] primary

primary

::= atom

|answer-ref
|function-ref
|′(′scalar_exp′)′

atom

::= STRING

|INTEGER
|FLOATING
|NULL

function-ref

::= COUNT′(″*″)′

|group-arithmetic-function-ref
|group-rank-function-ref
|each-function-ref

group-arithmetic-function-ref

::= {AVG|MAX|MIN|SUM|COUNT} ′(′answer-ref′)′

group-rank-function-ref

::={NTH_VAL|NTH_NUM|NTH_PCT}′(’answer-ref,rank′)′

each-function-ref

::= VALUE’(’answer-ref’)’

question

::={NAME|NEXT}

answer-ref

::=[question]NAME

|CONTENT′(′[question]NAME′)′

rank

::= INTEGER

A client can add a QCL sentence to each question. The central controller provides one question to respondents, collects responses from the respondents in a predetermined period of time, and then, executes the QCL sentence. The QCL may construct a logic by using the results of a plurality of responses.

In order to clearly show application method of the QCL, examples of the QCL applicable to the survey will be explained below.

One example is a case where a question is an open type of question and the A1 response is a numeral input type.
GROUP: IF (AVG (Q1.A1)>=14) THEN GOTO Q2;
If an average of the A1 responses to the Q1 question is larger than 14, perform the Q2 question.

Another example is a case where a question is a closed type of question and the A1 response is a type of selecting a response list number.
GROUP: IF (NTH_VAL (Q1.A1, 1)=2) THEN GOTO Q2;
If most respondents select no. 2 in the A1 response to the Q1 question, perform the Q2 question.

A further example is a case where a question is a closed type of question and the A1 response is a type of selecting a response list number.
GROUP: IF (NTH_NUM (Q1.A1, 1)=COUNT (Q1.A1)/2) THEN GOTO Q2 ELSE NEXT;
If the number of respondents selecting the highest ranking answer in the A1 response to Q1 question is larger than 1/25 of that of participants in the survey, perform the Q2 question, and if not, perform the next question.

A still further example is a case where question is a closed type of question and the A1 response is a type of selecting a response list number.
GROUP: IF ((NTH_VAL (Q1.A1, 1)=2, AND (NTH_VAL (Q1.A2, 1)=1) ) THEN GOTO Q2 ELSE GOTO Q3;
In a case where the highest ranking answer in the A1 response to the Q1 question is 2 and the highest ranking answer in the A2 response to the Q2 question is 1, perform the Q2 question, and if not, perform the Q3 question.

Although the preferred embodiment according to the present invention has been described in detail as the above mentioned, the scope of the present invention is not limited to the specific embodiment. The present invention should be constructed as being defined by the appended claims.

### INDUSTRIAL APPLICABILITY

As described above, according to the present invention, it is possible to greatly reduce the time and procedures required for conducting a survey. It is because a survey request, cost settlement, the survey and a report on the survey are performed in real time with respect to a community organized online.

It is especially available for a survey including some simple questions or a preliminary survey.

Furthermore, according to the present invention, since the survey cost is determined in the client-driven manner, it is possible to request the survey with a low cost. Since it is not necessary to have trouble in searching the respondents in accordance with the request of the survey client, if the number of questions for the survey is small, it is possible to request the survey with a lower cost. It is also applicable to cases of determining a movie title, a record title, a book title, a product's name, a store's name and the like. In a conventional offline survey, the number of the respondents plays an important role in estimating the survey request cost, whereas in the real-time online survey according to the present invention, the number of questions is a most important factor in the estimation of the survey request cost. A client can play a leading role in determining the request cost for each question. In other words, in case of an urgent survey, the possibility of bidding of the survey can be raised by presenting a higher request cost, and when considering the cost as a key factor, it is possible to wait for the bidding of the survey through many times of requests by presenting the lower request cost.

Furthermore, according to the present invention, it is possible to plan efficient questions for the survey by applying a skip pattern to a group. Instead of preparing questions having a complex skip pattern, the survey client can perform one question and then again request another question based on the result of the previous question.

Furthermore, according to the present invention, since only a client requiring information on a community having a common characteristic requests the survey, it is possible to solve the representation-related problem of a sampling group which has been indicated as a disadvantage in the Internet survey. Furthermore, since a voluntarily organized community is active, it is possible to enhance the reliability of the survey.

Furthermore, the present invention is applicable to an online advertisement. The online advertisement is a kind of buyer-driven system in the sense that a buyer (advertiser) searches a seller (person who views the advertisement) through public relation activities. It is difficult to construct an offline seller-driven system in which a seller (person who views the advertisement) searches a buyer (advertiser) in the same way as the market of the survey. However, according to the present invention, it is possible to construct an online seller-driven system in which the buyer is searched after constructing a community of sellers. The survey time is assigned to a person who provides the highest price for the community, but it is possible to set the cost of advertisement or survey in accordance with the number of currently connected persons (and matters of interest).

Furthermore, the present invention is applicable to a case where the individual activities have not a great value but the aggregated activities have a greatest value, among the activities performed online. The examples of such a case are a case of making a product by jointly using the ideas of many persons, an activity in which persons having a matter of common interest view an advertisement, an activity in which many persons write a composition together, an activity in which many persons evaluate some subjects or products together, and the like. Even offline, there is often a case where several novelists write a novel or several specialists in a field make a product. However, if they are not famous, it is difficult to search a customer and also to search a person who they will cooperate with. The present invention allows the persons to easily search a customer and to easily search a person who he will cooperate with.

1. A real-time and bi-directional respondent-driven survey method comprising:
the survey plan providing step of connecting a computer of a survey planner with an Internet, recording said survey plan to be conducted in a predetermined period of time into a survey plan database, and providing said survey plan to a plurality of survey request expectants and survey response expectants recorded in a member database through said Internet;
the qualification granting step of online receiving applications of a plurality of survey respondents who want to participate in said survey plan through said Internet, recording said survey respondents into a survey participant database, and granting said response participants qualifications for responding to a real-time survey to be conducted based on said survey plan;
the client determining step of providing the plurality of said survey request expectants with information on said response participants including the number of said response participants, a sampling error, ages, sexes, resident regions and the like, receiving a survey request condition including question contents, the number of questions, request costs, whether the results of said survey will be opened to the pubic and the like from the plurality of said survey request expectants, and determining a request expectant who has presented the best request condition as a client; and
the survey conducting step of recording said questions provided by said determined client into a question database, providing said questions to the plurality of said response participants in real time through said Internet, collecting the results of the responses to said questions from said response participants in real time through said Internet, recording said results into a response result database, and providing said results to said determined survey client in real time through said Internet.

2. The real-time and bi-directional respondent-driven survey method as claimed in claim 1, wherein said survey plan providing step further comprises the steps of:
determining an object, a subject, a survey conducting date and the number of participating expectants of said-real time survey plan and notifying a central controller of them; and
providing information on said real-time survey plan to said request expectants or said response expectants who want to participate in said real-time survey.

3. The real-time and bi-directional respondent-driven survey method as claimed in claim 1, wherein said qualification granting step comprises the step of:
selectively granting said qualifications to said logged-on response expectants by referring to the contents of member evaluation in said member database and by selectively granting said qualifications for a response participant and a response waiter in accordance with the order of applications, said contents of said member evaluation or the like.

4. The real-time and bi-directional respondent-driven survey method as claimed in claim 1, wherein said client determining step further comprises:
upon determination of said best request condition, the real-time auctioning step of assigning weighting factors to types and the number of questions, calculating said request cost per a question, and selecting said request expectant who has presented the highest request cost.

5. The real-time and bi-directional respondent-driven survey method as claimed in claim 1, wherein said client determining step further comprises the step of:
when said survey request expectant prepares a question form, inputting a skip pattern of said questions for determining the next question in accordance with the results of responses of respondents to a previous question.

6. The real-time and bi-directional respondent-driven survey method as claimed in claim 5, wherein said step of inputting said skip pattern of said questions further comprises the step of inputting a skip pattern for the results of a response of an individual respondent and a skip pattern for the results of responses of all respondents.

7. The real-time and bi-directional respondent-driven survey method as claimed in claim 1, wherein said survey conducting step includes a wire or wireless Internet as a question and response media.

8. The real-time and bi-directional respondent-driven survey method as claimed in claim 1, wherein said survey conducting step further includes the step of outputting, through said Internet, a report by statistically analyzing said results of said survey according to a predetermined format during said survey or immediately after ending of said survey.

9. The real-time and bi-directional respondent-driven survey method as claimed in claim 1, further comprising the step of:
after constructing a period of said survey with said client determining step and said survey conducting step and forming a sequence of said survey including different questions at each period, sequentially conducting said survey in accordance with said sequence of said survey until an end time of said survey.

10. The real-time and bi-directional respondent-driven survey method as claimed in claim 3, wherein said step of selectively granting said qualifications further comprises the step of:
when said number of said response participants becomes smaller than a predetermined number of said response participants in the course of said survey, maintaining said number of said response participants constant by selectively converting said response waiter into said response participant.
